(19) United States
(12) Patent Application Publication
(10) Pub. No.: US 2023/0384192 A1
(43) Pub. Date: Nov. 30, 2023

(54) IMPROVEMENTS IN OR RELATING TO FLUID SAMPLE PREPARATION

(71) Applicant: DNAe Diagnostics Limited, London (GB)

(72) Inventors: Alessandro MARTURANO, London (GB); Henry Oluseyi FATOYINBO, London (GB); Atreyee SAHA, London (GB); Jarrett KILLPACK, London (GB)

(73) Assignee: DNAe Diagnostics Limited, London (GB)

(21) Appl. No.: 18/249,123

(22) PCT Filed: Oct. 15, 2021
(86) PCT No.: PCT/GB2021/052679

§ 371 Date: Apr. 14, 2023

(30) Foreign Application Priority Data
Oct. 16, 2020 (GB) 2016433.1

(51) Int. Cl. G01N 1/40; G01N 1/38; B01D 65/08; B01D 29/86; B01F 33/452; B01D 61/18

(52) U.S. Cl. CPC G01N 1/4077; G01N 1/38; B01D 65/08; B01D 2321/2025; B01F 33/452; B01D 61/18; G01N 2001/4088; B01D 29/86

(57) ABSTRACT

A filtration unit for separating at least one analyte from a fluid sample. The filtration unit includes: an inlet configured to receive the fluid sample and an outlet configured to receive the at least one analyte; a fluid pathway providing fluid communication between the inlet and the outlet, where the fluid pathway has a longitudinal axis along which the fluid sample flows, in use; a filter located in the fluid pathway, where the filter includes at least one surface configured to allow the passage of the at least one analyte and the at least one surface is substantially transverse to the longitudinal axis of the fluid pathway; and an impeller located adjacent to the filter, where the impeller is configured to generate tangential fluid flow in the vicinity of the filter and wherein the impeller includes a rotatable shaft coupled to at least one blade having a rounded leading edge.

### FIELD OF THE INVENTION

The present invention relates to improvements in or relating to fluid sample preparation and, more specifically, to fluid sample preparation via stirred dead-end filtration.

### BACKGROUND

Whole blood contains a variety of constituents, which for analytical purposes must be prepared or cleaned-up prior to downstream processes such as analyte detection or genome sequencing. Leukocytes, thrombocytes and erythrocytes, known collectively as haematocrit, normally accounts for as much as ^{˜}46.7% v/v with plasma, which itself is around 92% water and around 8% blood plasma analytes, accounting for the remainder of the whole blood volume. As a result of the high percentage volume of the haematocrit, the removal of interferants upstream of a bioprocess enables reliable subsequent downstream processes. For example, high haemoglobin levels from red blood cell lysis have been shown to have detrimental effects on the results of antigen-antibody based assays. Thus, manufacturers of analyzers usually perform interference testing on their devices to ascertain the acceptability criteria of interferences, defined by the cut-off value (Clinical and Laboratory Standards Institute (CLSI)).

In attempting to eliminate interfering substances from being carried over into subsequent processing steps, for example cells, haemoglobin, genetic material from lysed blood cells, processing parameters and design variables must be considered and chosen appropriately to maximise efficiency of that unit operation. In the case of circulating cell-free DNA (cfDNA) targeted for capture from whole a range of processing variables need to be considered to enable further downstream processing towards sequencing.

Design Considerations for cfDNA concentration from whole blood with a dead-end filtration system (DEF) can be based on molecular/particle size, shape, and charge. Molecules larger than the membrane pores will not penetrate within the membrane void volume (Ultrafiltration Membranes), whilst particles/molecules that are deformable or smaller than the filter input-side pores can be captured within the polymer matrix (Microporous Membranes). Importantly, empirical testing will always be required to design any filtration system.

Human plasma is the most important and one of the most convenient sources of circulating biomarkers. Studies on plasma proteome, transcriptome and metabolome have rapidly increased the spectrum of diagnostic targets for a wide range of diseases, including cancer, Alzheimer's and sepsis.

Likewise, antibodies, as well as foreign nucleic acids and antigens present in plasma, allow for the diagnosis of serious infectious diseases such as those caused by Ebola or Zika viruses. Furthermore, separating plasma from blood is a critical step to enable further downstream processing, such as DNA extraction. However, the quality of biomarkers often depends not only on biological factors such as physical condition and age of the patient but also on technical factors such as the lack of standardization of sample collection and preparation. Furthermore, handling blood samples is time-sensitive as genetic material can degrade and metabolites can break down.

Current methods used in laboratories to separate plasma from blood involve numerous processing steps. This often involves several freeze/thaw steps, transfer of samples from one tube to another and centrifugation of samples. This is labour intensive, time-consuming and is often associated with the risk of human error and/or leakage which can often result in unusable samples.

The potential utility of circulating tumour DNA (ctDNA) in patients' blood for cancer diagnostics and real-time monitoring of disease progression is a highly recognized alternative method to tissue biopsies. However, bar the application of multi-step centrifugation processes, the lack of automated and efficient methods for plasma separation from peripheral blood for circulating cell-free DNA (cfDNA) isolation remains a challenge. Isolation of cfDNA commonly relies on a sample preparation method called fractioning which consists of the separation of plasma from cellular constituents using a laboratory centrifuge. Although centrifugation is a widely used method to separate plasma, due to several manual steps required, final volumes are invariably inconsistent and the risk of cell contamination significant due to human error. In addition, centrifugation can be challenging to implement into in vitro diagnostic (IVD) systems which need to be user-friendly, compact, and automated to yield reliable and accurate results. There are many IVD technologies available for small volume (<1 ml blood) plasma separation, but these have been deemed unsuitable to efficiently and rapidly process the quantities of blood needed to extract sufficient cfDNA (i.e. 10-50 ml blood) for further downstream processing. Other solutions identified able to handle this range of volume rely on ‘bed-side’ equipment which is bulky and in direct contact with the patient (i.e. apheresis).

One approach to separating an analyte, such as a protein, from a fluid sample, such as whole blood or plasma, is by using tangential flow filtration (TFF). In TFF the majority of the fluid flow travels tangentially across the surface of the filter, rather than perpendicularly into the filter—referred to as dead-end filtration (DEF). TFF is typically used for fluids containing a high proportion of small particle size solids (e.g. cfDNA) because solid material (e.g. cells) can quickly foul the filter surface with dead-end filtration. The main advantage of TFF is that the filter cake is substantially washed away during the filtration process.

The main driving force of the (TFF) process is transmembrane pressure. However, during the process, the transmembrane pressure might decrease due to an increase of permeate viscosity, therefore filtration efficiency decreases over time and can be time-consuming for large-scale processes. This can be prevented by diluting the permeate or increasing the flow rate of the system which is not ideal when dealing with scarce analytes such as cfDNA.

It is against this background that the present invention has arisen.

According to the present invention, there is provided a filtration unit for separating at least one analyte from a fluid sample, the filtration unit comprising: an inlet configured to receive the fluid sample and an outlet configured to receive the at least one analyte; a fluid pathway providing fluid communication between the inlet and the outlet, wherein the fluid pathway has a longitudinal axis along which the fluid sample flows, in use; a filter located in the fluid pathway, wherein the filter comprises at least one surface configured to allow the passage of the at least one analyte and wherein the at least one surface is substantially transverse to the longitudinal axis of the fluid pathway; and an impeller located adjacent to the filter, wherein the impeller is configured to generate tangential fluid flow in the vicinity of the filter and wherein the impeller comprises a rotatable shaft coupled to at least one blade having a rounded leading edge.

The addition of an impeller adjacent to the filter and configured to generate tangential fluid flow imposes transmembrane pressures that continuously drive the analyte through the filter. The impeller may be located between the inlet and the filter. Locating the impeller between the inlet and the filter ‘pushes’ the analyte through the filter. Alternatively, or in addition, the impeller may be located between the filter and the outlet. Locating the impeller between the outlet and the filter ‘pulls’ the analyte through the filter.

The filtration unit may comprise at least two impellers. Alternatively, the filtration unit may comprise a plurality of impellers. For example, the filtration unit may comprise at least 1, 2, 3, 4, 5 or more than 5 impellers. The filtration unit may comprise at least one impeller located between the inlet and the filter and at least one impeller located between the filter and the outlet.

An impeller located between the inlet and the filter confers 3 benefits, namely: promoting TFF, via a rotational fluid motion, within a small filter footprint that is ideal for a diagnostic device; imposing transmembrane pressures that continuously drives the plasma through the filter; and physical removal of particles from the filter surface via a ‘wiper’ type process, thus preventing filter fouling.

An impeller located between the filter and the outlet confers various benefits, including: promoting TFF, via a rotational fluid motion, within a small filter footprint that is ideal for a diagnostic device; imposing transmembrane pressures that continuously drives the plasma through the filter; and mixing of the samples on both sides of the filter.

The exploitation of the radial motion transmitted by the impeller results in continuous recirculation of the fluid and produces perpendicular fluid forces driving the analyte through the filter without need of external pressure. However, external pressure may be used to accelerate fluid flow through the filter/membrane.

More specifically, the impeller may be configured to generate tangential fluid flow in the vicinity of the filter. For example, the impeller may be positioned such that the tangential fluid flow may be generated across the first surface of the filter. Alternatively, or in addition, the impeller may be positioned such that the tangential fluid flow may be generated within the fluid up to 20 mm away from the filter. In some embodiments, tangential fluid flow may be generated up to 0.1 mm, 0.2 mm, mm, 0.4 mm, 0.5 mm, 0.6 mm, 0.7 mm, 0.8 mm, 0.9 mm, 1 mm, 2 mm, 5 mm, 10 mm, 15 mm, 20 mm, 30 mm, or 50 mm away from the filter. The tangential fluid flow is configured to increase the pressure difference across the filter, thus driving the analyte through the filter. The filtration unit may be used for, but is not limited to, the downstream processing of cfDNA for early cancer detection.

Other applications include extraction of proteins, RNA, DNA, and exosomes of human, bacterial, or viral origin. The fluid sample may be supplied in discrete batches via the inlet. Alternatively, the fluid sample may be continuously supplied to the filtration unit via the inlet.

The rotating impeller may impose a tangential fluid flow and/or a crossflow, over the at least one surface of the filter, thus generating a pressure differential across the filter which may drive the fluid flow across the at least one surface of the filter.

The impeller may be replaceable. The impeller may be replaced depending on the analyte to be separated. A replacement impeller may comprise different characteristics. The impeller characteristics may comprise at least one of: biocompatibility of the material of fabrication of the impeller; the number of blades and the geometry of the blades.

The at least one blade may be substantially planar. The at least one blade may comprise a first surface and an opposing second surface. The at least one blade may comprise at least one edge configured to connect the first surface with the second surface. The at least one edge may be rounded. A rounded edge minimises cell damage and lysis of the fluid sample constituents and/or analyte. Therefore, in some embodiments, all the blade edges may be rounded. In particular, the leading edge may be rounded. Consequently, the shear stress applied by the impeller to the sample, in use, is minimised.

At least a portion of the at least one edge may be substantially parallel to the at least one surface of the filter. Alternatively, or in addition, at least a portion of the at least one edge may be at an angle relative to the at least one surface of the filter.

The first surface and/or second surface of the at least one blade may be at an angle α relative to the longitudinal axis of the fluid pathway. The angle α may be up to 10, 20, 30, 40 or 45 degrees. Alternatively, or in addition, the angle α may be at least 45, 50, 60, 70 or 80 degrees. Conversely, in some embodiments, the first surface and/or second surface of the at least one blade may be substantially parallel to the longitudinal axis of the fluid pathway. Thus, in such embodiments, the angle α may be approximately 0 degrees.

In some embodiments, the first surface and/or second surface of the at least one blade may be curved. The blade may curve in a plane parallel and/or perpendicular to the longitudinal axis of the fluid pathway.

In some embodiments, the impeller may comprise a plurality of blades each having a rounded leading edge. This increases the TFF, thus increasing the rate of filtration, whilst minimising the amount of cell lysis that occurs within the sample. Moreover, the rotatable shaft may be circular in cross section. This further reduces the cell damage and lysis of the fluid sample constituents and/or analyte.

The impeller and/or blade(s) may be smooth. For example, the impeller and/or blade(s) may be polished. The polish may be configured to remove material from the surface of the impeller in order to increase the smoothness.

The impeller and/or blade(s) may be 3D printed. The material used may be mouldable. Alternatively, or in addition, the impeller may be fabricated from biocompatible and/or bio-inert materials, such as perfluoroalkoxy (PFA), polypropylene (PP) or polytetrafluoroethylene (PTFE). The impeller may be non-haemolytic.

The filtration unit may be a single-use device. Thus, after use, the filtration unit may be discarded. Alternatively, elements of the filtration unit may be disposed of, wherein the disposable elements comprise the filter and the impeller.

The impeller may be spaced apart from the filter. For example, at least a portion of the at least one blade may be positioned approximately 0.5 mm away from the filter. In some embodiments, at least a portion of the at least one blade may be positioned up to 0.001 mm, 0.005 mm, 0.01 mm, 0.1 mm, 0.3 mm, 0.5 mm, 0.7 mm, 1 mm, 2 mm, 5 mm, 10 mm or 20 mm away from the filter. Increasing the distance between the blade and the filter may increase the pressure difference created across the filter.

Alternatively, in some embodiments, at least a portion of the at least one blade may be configured to contact the filter. For example, at least a portion of the at least one blade may be configured to sweep the retentate from the filter.

The at least one blade may be spaced apart from a side wall of the fluid pathway. For example, at least a portion of the at least one blade may be positioned approximately 0.5 mm away from a side wall of the fluid pathway. In some embodiments, at least a portion of the at least one blade may be positioned up to 0.001 mm, 0.005 mm, 0.01 mm, 0.1 mm, 0.3 mm, 0.5 mm, 0.7 mm, 1 mm, 2 mm, 5 mm, 10 mm or 20 mm away from a side wall of the fluid pathway. This may further minimise the amount of cell lysis that occurs within the sample.

The filter may be replaceable. The filter may be replaced depending on the analyte to be separated. Alternatively, or in addition, the filter may be replaced depending on the fluid sample. The filter may be selected based on at least one of pore size; biocompatibility with the fluid sample and/or analyte; and surface charge.

The pore size may be selected to ensure that the analyte can pass through the filter. Alternatively, or in addition, the pore sizes may be selected to ensure that at least one predetermined retentate cannot pass through the filter. A filter with suitable biocompatibility with the analyte may be selected to prevent the analyte from damage or lysis prior to separation. The filter may also be selected based on its surface charge in comparison to that surface charge of the analyte for separation. A filter with un-opposing surface charge will prevent the analyte from attracting to the filter and will assist with preventing the filter from becoming blocked.

At least one surface of the filter may be woven. Alternatively, or in addition, at least one surface of the filter may be track-etched. This enables more precise pore sizes within the filter, thus enabling predetermined transportation and retention characteristics to be achieved.

The at least one surface of the filter may be substantially perpendicular to the longitudinal axis of the fluid pathway.

A filter substantially perpendicular to the longitudinal axis of the fluid pathway enables the use of slower flow rates within the fluid pathway than traditional TFF filtration units. This prevents the retentate from needing to be diluted and therefore prevents the permeate from being diluted as a result. However, in some embodiments, depending on the analyte to be separated, the fluid sample may be diluted. Alternatively, or in addition, the fluid sample may be diluted before being supplied to the filtration unit. For example, the fluid sample may be diluted when continuously supplied to the filtration unit.

The at least one surface of the filter may comprise a plurality of pores sized between 100 nm and 10 μm. Pore sizes of between 1 nm and 10 μm enables a chosen analyte, such as a protein from a fluid sample such as plasma, to pass through the filter whilst preventing other larger components, such as red blood cells, within a fluid sample, such as whole blood, from passing through. The filter may be made of Polyvinylidene fluoride (PVDF) or Polytetrafluoroethylene (PTFE), although any suitable material may be used. For example, a filter comprising at least one surface fabricated from PVDF may comprise pore sizes of approximately 0.65 μm. Alternatively, approximately 1 μm pore size may be used with at least one surface of a filter fabricated from PTFE.

The filter may be up to 5 mm thick. Alternatively, the filter may be up to 0.1 mm, 0.2 mm, 0.3 mm, 0.4 mm, 0.5 mm, 0.6 mm, 0.7 mm, 0.8 mm, 0.9 mm, 1 mm, 2 mm, 5 mm or 10 mm thick. The thickness of the filter may vary. The thickness of the filter may be varied depending on the fluid sample or the analyte for separation.

The filtration unit may comprise a plurality of filters. A plurality of filters may improve the filtration rate by separating larger components from the fluid sample during an initial filtration step and separating smaller components from the fluid sample in a subsequent filtration step. This may prevent the filter from becoming blocked or clogged up. The different grades of filter may be provided as separate filters or they may be combined into an asymmetrical filter structure where the upstream side has larger pore size than the downstream side.

The fluid pathway may be a conduit. The conduit may comprise a differing cross sectional area along its length. There may be a large cross sectional area portion to accommodate the impeller with the cross sectional area both upstream and downstream being reduced. The conduit may comprise at least one sidewall. The conduit may comprise a plurality of sidewalls as the pathway is divided into a plurality of microfluidic channels. A conduit more clearly defines the boundary of the fluid pathway. The conduit may be substantially circular in cross-section as this may prevent any dead-spots or reduced fluid flow rates in corners, for example. A circular cross-section also enables the impeller to uniformly interact with the fluid sample and/or analyte within the fluid pathway. Furthermore, a fluid pathway that is circular in cross-section may be easier to manufacture than other more complex geometries. However, any shaped fluid pathway may be used, including substantially ‘D-shaped’ cross-sections, ‘U-shaped’ cross-sections, ‘V-shaped’ and semi-circular cross-sections. At least a portion of the fluid pathway adjacent to the filter and located between the filter and the outlet may comprise a substantially flat surface.

The fluid pathway may comprise a first chamber. The first chamber may be located between the inlet and the filter. The first chamber may be located adjacent to the filter. The first chamber may have a greater cross-sectional area than the inlet. The first chamber may have a greater cross-sectional area than the outlet. The first chamber may be configured to receive the fluid sample to be filtered. The first chamber may be configured to temporarily store the fluid sample to be filtered. The first chamber may be configured to control the flow rate of the fluid sample in the vicinity of the filter. The fluid chamber may comprise a plurality of chambers.

The first chamber may comprise an opening configured to remove at least a portion of the fluid sample. The opening may be configured to remove at least a portion of the retentate. The opening may be adjustable, wherein the adjustable opening is configured to adjust the flow rate across the filter. The adjustable opening may be fully open, partially open or closed.

The fluid flow rate through the filter may be up to 100 ml per hour. Alternatively, the fluid flow rate through the filter may be up to 5 ml, 10 ml, 15 ml, 20 ml, 25 ml, 35 ml, 40 ml, 50 ml or 75 ml per hour. In some embodiments, the fluid sample may be filtered at approximately 20-30 ml per hour to separate sufficient quantities of an analyte such as cfDNA. The filter characteristics and/or impeller characteristics, hence fluid flow rate through the filter, may be adjusted based on the analyte.

In some embodiments, approximately 10-30 ml of a filtrate may be separated from the sample in less than 20 mins. Accordingly, the fluid flow rate through the filter may be up to 100 ml per hour. In such embodiments, the sample may have a low viscosity and/or low cell density. For example, the sample may be urine; Cerebrospinal fluid (CSF) or environmental water.

Alternatively, in some embodiments, approximately 5-10 ml of plasma may be separated from a whole blood sample in less than 20 mins. Accordingly, the fluid flow rate through the filter may be up to 30 ml per hour.

The rate of filtration (dt/dV) is measured as the rate at which liquid filtrate is collected, and it depends on:
Area of the filter membrane (A)
Volume of filtrate (V)
Filtrate viscosity (μ_{f})
Specific cake resistance (particle size and shape dependent) to flow (α)
Total mass of solids in filter cake (M_{c})
Pressure difference across the filter (ΔP)
Resistance to filtration by the filter and any solids wedged internally (rₘ)

$$\frac{1}{A} \frac{d V}{d t} = \frac{Δ P}{{μ}_{f} [ α ( \frac{{M}_{c}}{A} ) + {r}_{m} ]}$$

There are various different routes to improving the rate of filtration including:
1) Increasing the area of the filter, while all other process parameters remain constant. Following equation can be used for processing a sample in a specified time:

$$A = \frac{V}{J \times T}$$

Where,
   A=membrane area (m²)
   V=volume of filtrate generated (litres)
   J=filtrate flux rate (litres/m²/hour)
   T=processing time (hours)
2) Increase the filtration pressure drop, i.e. the transmembrane pressure, a quantity composed of various pressures within the system, and additional component of the downward pressure vector of the re-circulating fluid occurring during stirring.
3) Reduce the cake mass; this is achieved through the continuous angular frequency (ω) of the impellers sweeping the fluid in the proximity of the membrane ensuring minimal cake residue resides fixed on the filter surface.
4) Reduce the sample viscosity; sample material can optionally be diluted at the beginning of the process or through a diafiltration-type process.

The filtration unit may comprise a pump configured to increase the pressure difference across the filter. For example, the pump may be configured to increase the pressure between the inlet and the filter. Accordingly, the pump may be configured to generate a positive pressure between the inlet and the filter. Alternatively, or in addition, the pump may be configured to decrease the pressure between the filter and the outlet. Accordingly, the pump may be configured to generate a negative pressure between the filter and the outlet. Increasing the pressure differential across the filter may enable greater fluid flow rates across the filter to the achieved. For example, the pump may be used to generate flow rates through the filter of up to 100 ml per hour.

Typically, the flow rate through the filter will decrease over time. However, in some embodiments, the filtration unit may be configured to maintain a flow rate of 20-30 ml per hour through the filter. This may be achieved via the pump, as described above. For example, the power of the pump may increase over time to ensure a constant flow rate through the filter. Thus, the addition of a pump may be used to maintain a substantially constant flow rate through the filter. Moreover, the pump may comprise a control unit configured to ensure that the flow rate through the filter is maintained within a predetermined range.

The filtration unit may further comprise a motor operably connected to the impeller shaft. The motor may be configured to rotate the impeller, in use. The motor may be a stepper motor operably connected to the impeller shaft. The stepper motor may be configured to rotate the impeller shaft at 25-450 revolutions per minute (RPM), in use.

A stepper motor connected to the impeller via the shaft coupling provides the rotational motion needed to obtain the tangential flow and the transmembrane pressure in the filtration unit. Furthermore, the stepper motor ensures the impeller rotates at a sufficient speed to prevent the build-up of unwanted components on a surface of the filter.

In some embodiments, the impeller may comprise at least on magnetic material. The magnetic material may be caused to rotate by an opposing magnetic material located in the vicinity of the impeller, thus causing the impeller to rotate. Consequently, the impeller may be suspended in the fluid pathway by magnetic forces, thus removing the requirement for a mechanical connection.

In some embodiments, the impeller may comprise at least one fin configured to rotate about an axis substantially perpendicular to the longitudinal axis of the conduit. The at least one fin may be operably connected to the impeller shaft such that the fluid flow parallel to the longitudinal axis of the conduit causes the fins to rotate about their axis, which in turn causes the impeller to rotate. The at least one fin may be operably connected to the impeller shaft via a bevel gear. The at least one fin may be operably connected to the impeller shaft via a 90-degree bevel gear. The at least one fin may have a larger combined surface area than the combined surface area of the at least one impeller blade.

The fluid sample may comprise a particulate concentration in the range of 10⁰-10¹⁸ particles/ml. The fluid sample may comprise between 10⁰-10⁸ particles/ml of the analyte.

The fluid sample introduced into the unit may be plasma. In some embodiments, the analyte for separation may be at least one of proteins, DNA, RNA, exosomes, viral particle, bacteria, cell metabolites and circulating tumour cells. A suitable filter may be selected based on the analyte to be separated.

The fluid sample may be biological matter. For example, the fluid sample may be whole blood, viral transport medium, cerebral spinal fluid, nasopharyngeal fluid or stool. Alternatively, the fluid sample may be environmental matter, such as oil, petroleum, diesel particulate matter (DPM) or soil samples.

The fluid pathway may be sized to accommodate up to 30 ml of the fluid sample. In some embodiments, the fluid pathway may be sized to accommodate up to 1 ml, 5 ml, 10 ml, 15 ml, 20 ml, 25 ml, 30 ml, 25 ml, 40 ml, 45 ml, 50 ml, 70 ml, 100 ml, 200 ml, 500 ml or more than 500 ml of the fluid sample.

The filtration unit may comprise at least one reservoir for storing at least a portion of the fluid sample. The at least one reservoir may be located between the inlet and the filter. In some embodiments, the at least one reservoir may be located between the inlet and the impeller. The at least one reservoir may be configured to store at least a portion of the fluid sample before it is filtered. This enables larger volumes of fluid sample to be used whilst maintaining a desired fluid flow rate. Consequently, continuous filtration may be achieved by continuously supplying a fluid sample into the reservoir. The fluid sample may be stored within the at least one reservoir for up to 1 second, 10 seconds, 30 seconds, 1 minute, 5 minutes, 10 minutes, 20 minutes, 30 minutes or more than 30 minutes.

The filtration unit may be configured to be received by a stand. The filtration unit may be placed onto the stand, which includes a filtration unit holder, a stand top and a plurality of spacers connected to a bottom plate. Furthermore, the stand may be configured to be received by an external instrument. The external instrument may be configured to hold the motor.

In use, the filtration unit requires minimum personnel handling, thus it is adaptable to a downstream automation process as well as integration within a compact diagnostic device upon further miniaturisation. The process allows immediate separation of an analyte, such as a protein from components, such as blood cells, within a fluid sample, such as whole blood or plasma, for further analysis. A standardised device ensures uniformity of the results and thus is strongly advantageous over the current manual processing methods.

The invention will now be further and more particularly described, by way of example only, with reference to the accompanying drawings.

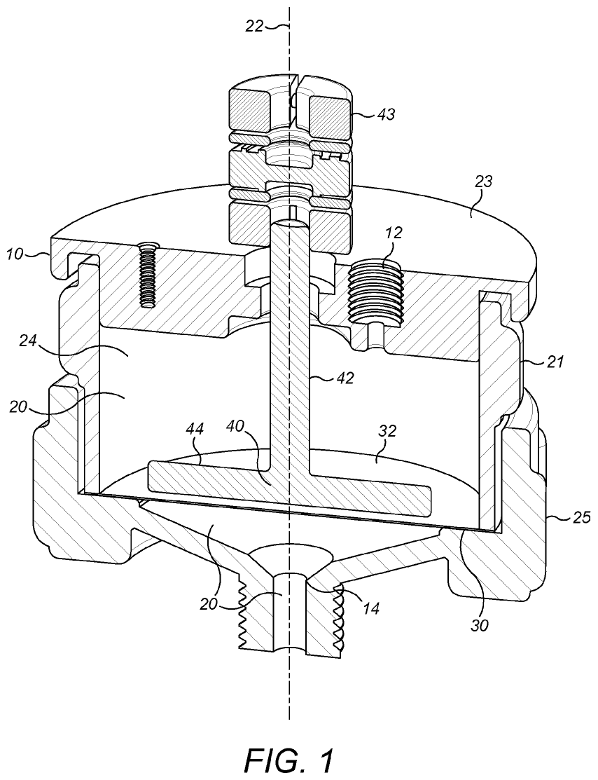

FIG. 1 shows the filtration unit;

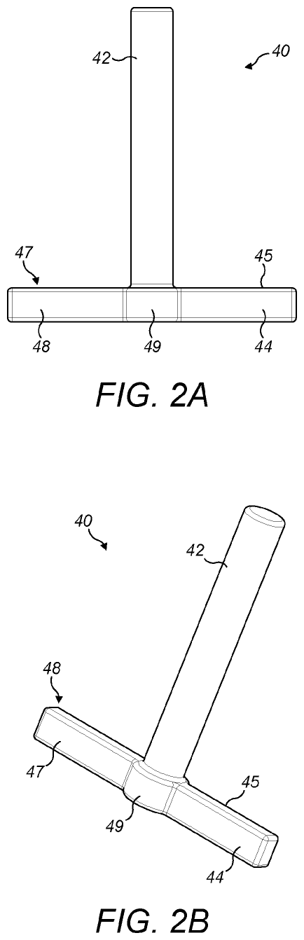

FIG. 2A shows an impeller for use in some embodiments of the invention;

FIG. 2B shows the impeller of FIG. 2A;

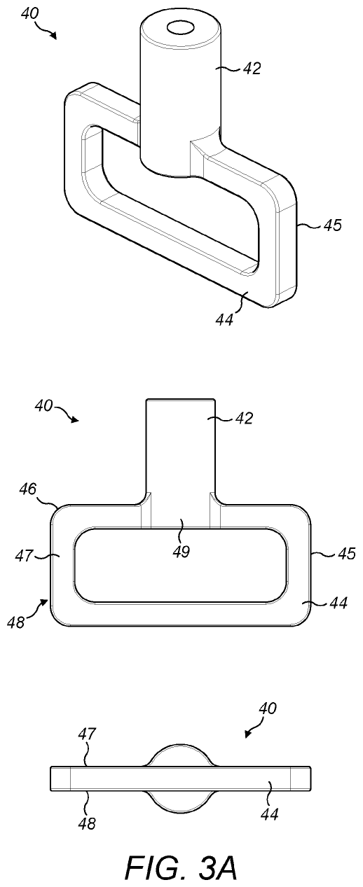

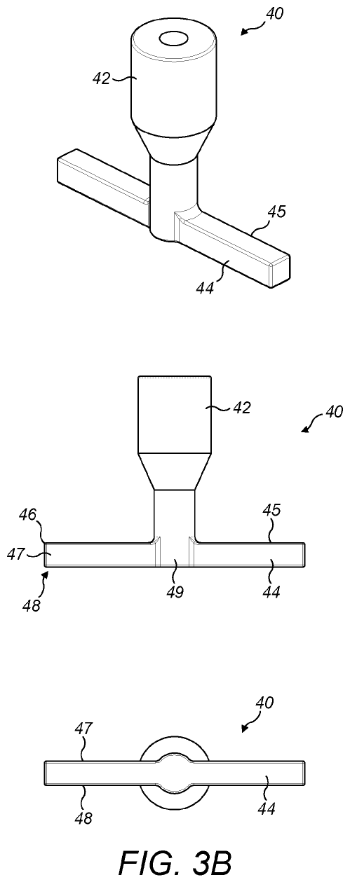

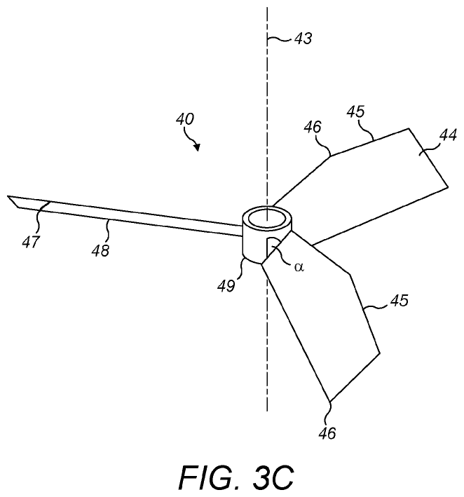

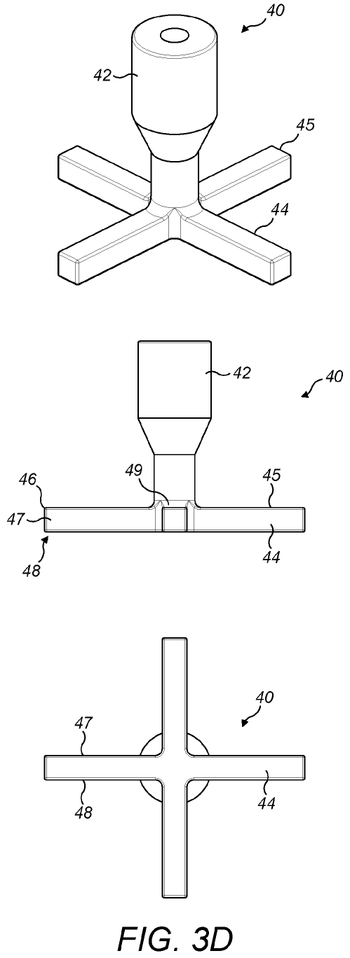

FIG. 3A shows an impeller comprising one blade;

FIG. 3B shows an impeller comprising two blades;

FIG. 3C shows an impeller comprising three blades;

FIG. 3D shows an impeller comprising four blades;

FIG. 3E shows an impeller comprising six blades;

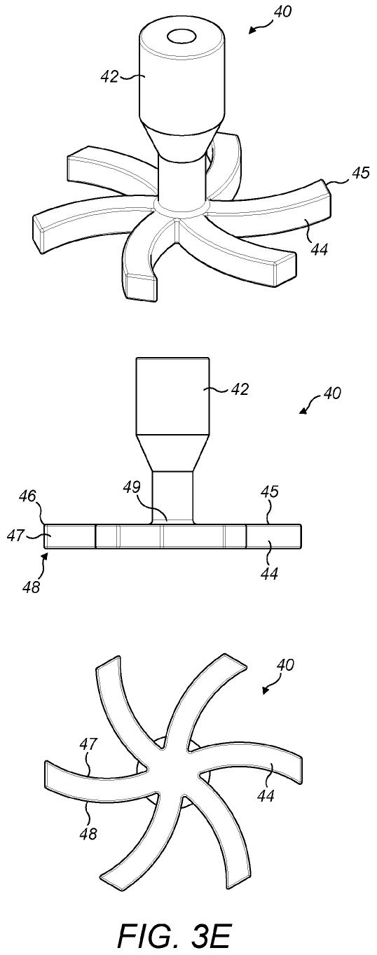

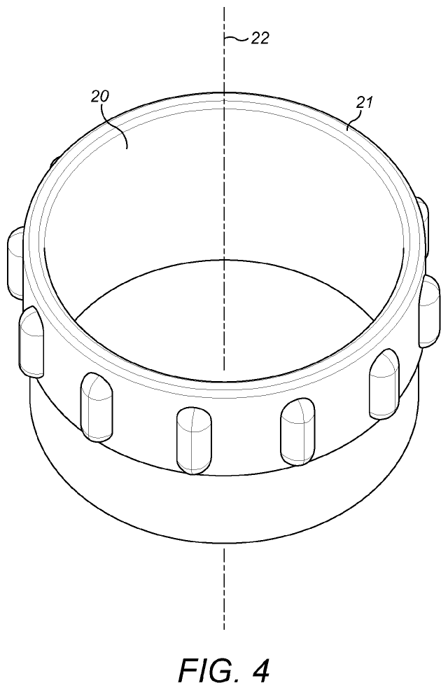

FIG. 4 shows a portion of the fluid pathway;

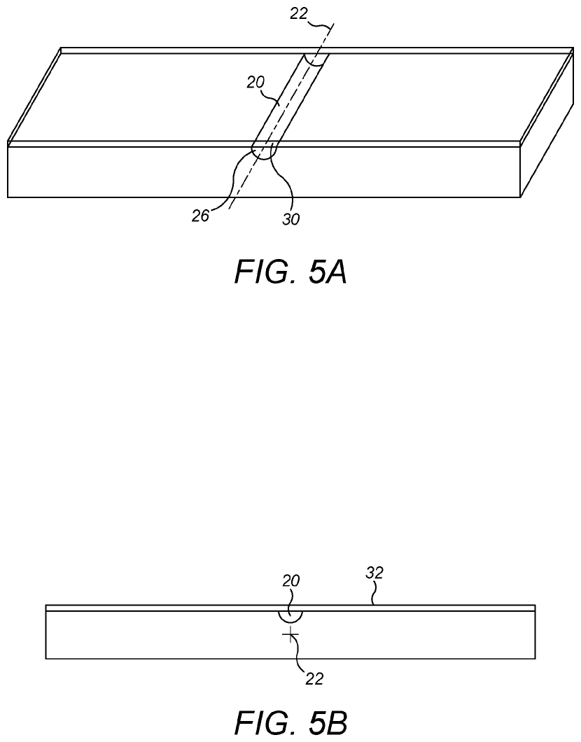

FIG. 5A shows the fluid pathway and filter in some embodiments of the invention;

FIG. 5B shows the fluid pathway and filter of FIG. 5A;

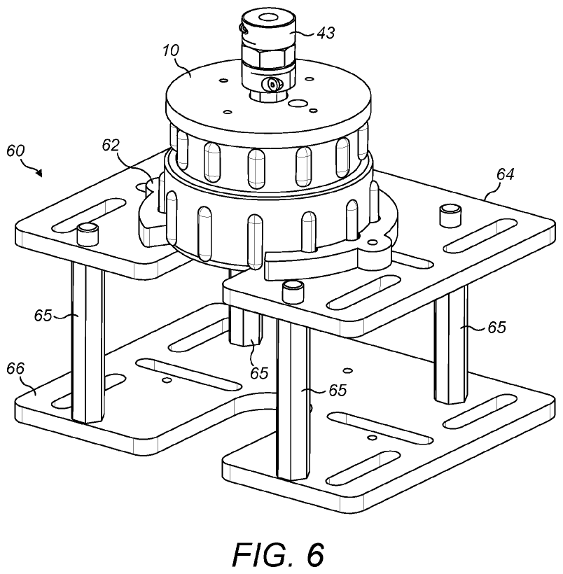

FIG. 6 shows a stand configured to receive the filtration unit;

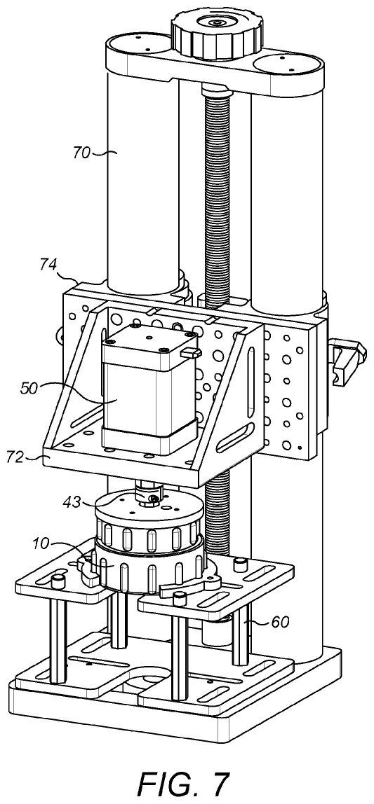

FIG. 7 shows an instrument configured to receive the stand of FIG. 6;

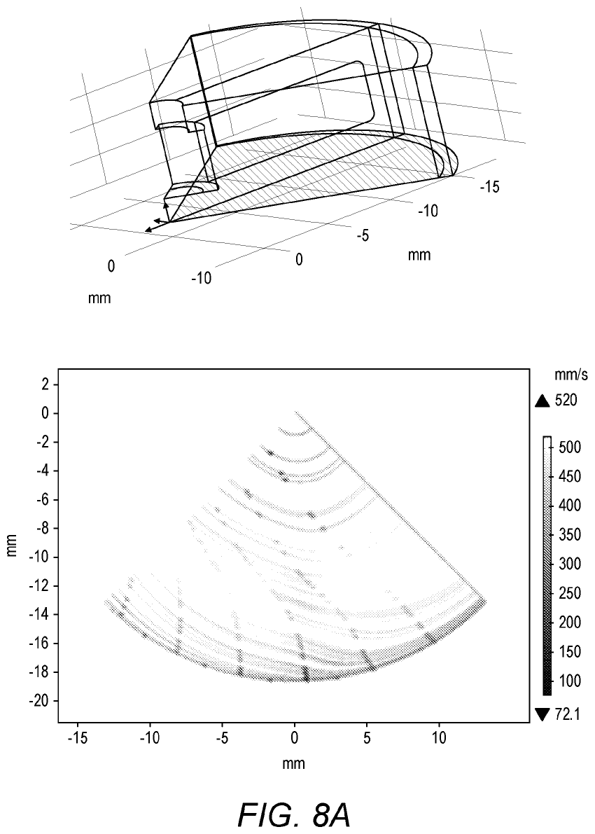

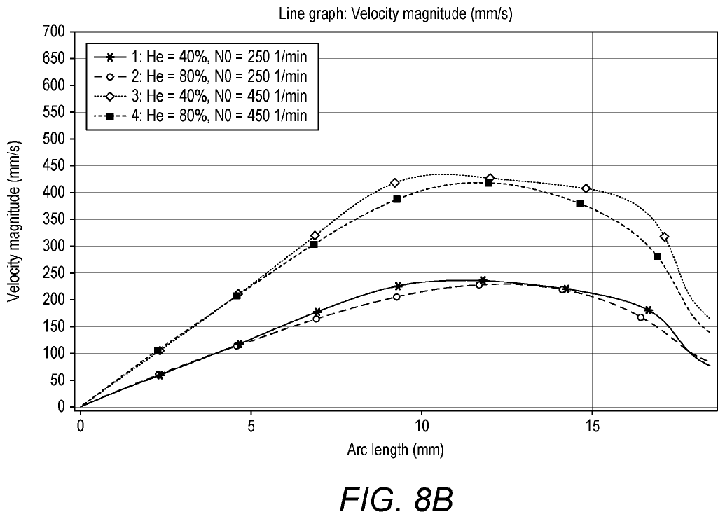

FIG. 8A shows flow velocity analysis at the bottom of the filtration unit (e.g. where the filter is placed) of blood stirred at 450 RPM showed that velocities ranged between 72-520 mm/s;

FIG. 8B shows that no change in flow velocity as a function of haematocrit was observed as the plasma passed through the filter with the hematocrit levels increased reaching levels of 80%;

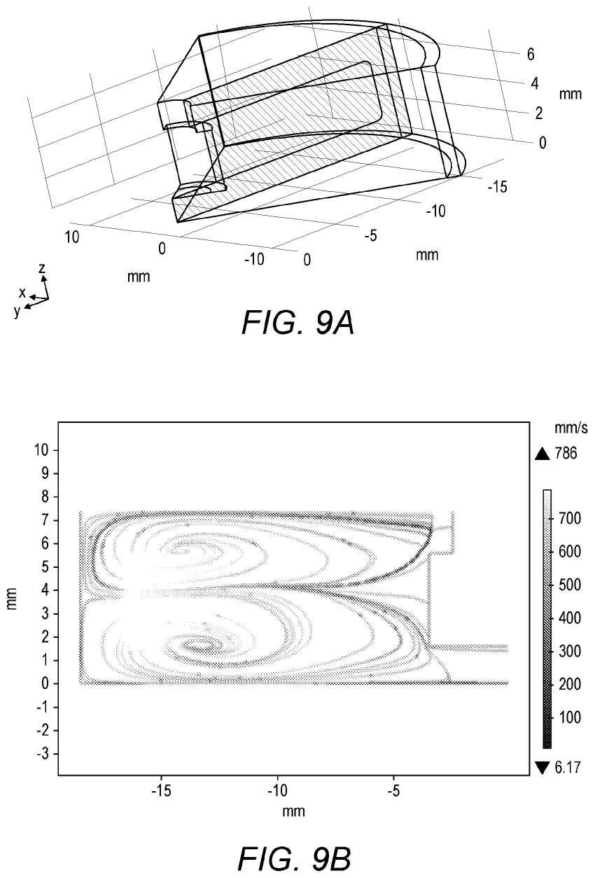

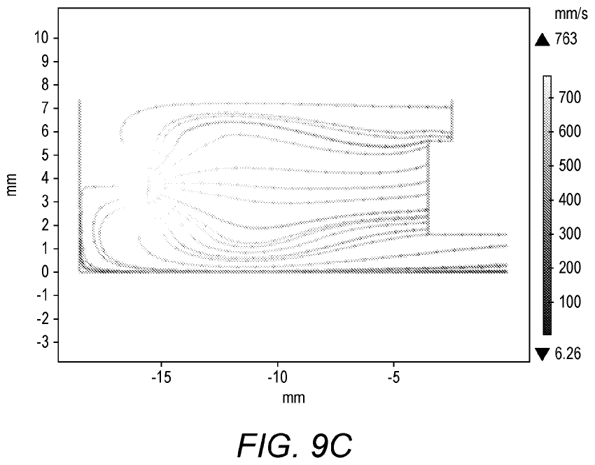

FIG. 9A shows, schematically, the movement of the impeller;

FIG. 9B shows the vortexes that are created behind the blade;

FIG. 9C shows the fluid flow in front of the impeller;

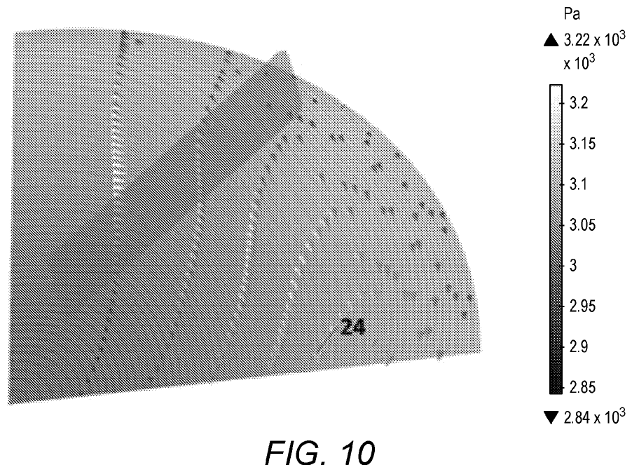

FIG. 10 shows the fluid motion and pressure imposed by the rotating blades;

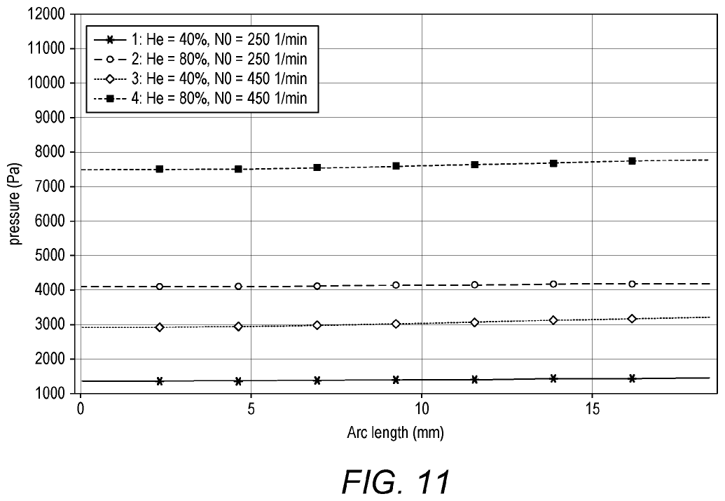

FIG. 11 shows pressure measurement within the filtration unit;

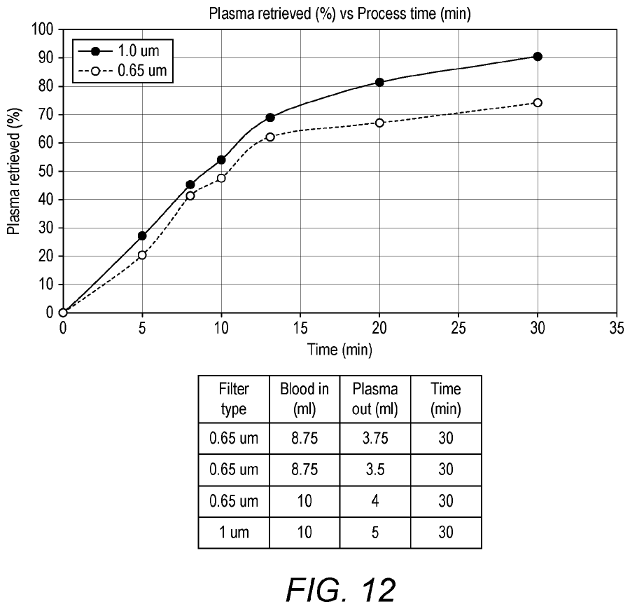

FIG. 12 shows the amount of plasma retrieved from a blood sample over time;

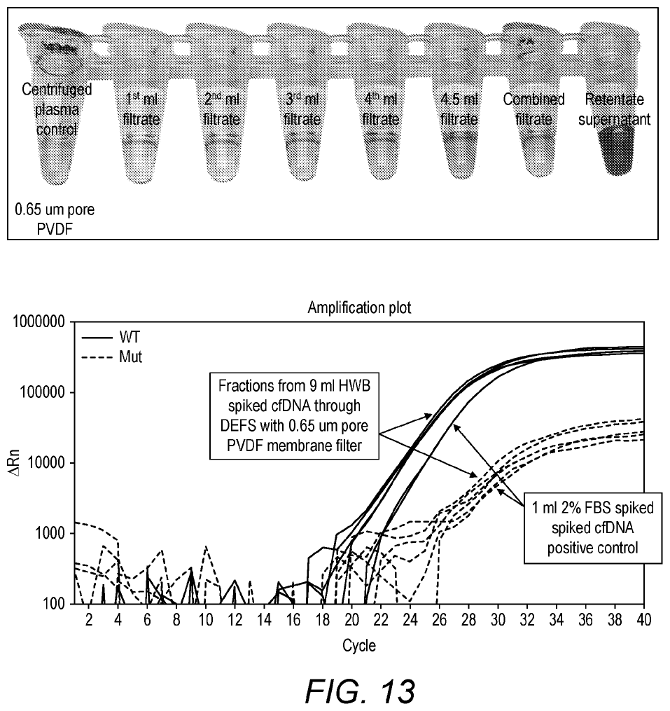

FIG. 13 shows the analyte separation capabilities of the filtration unit;

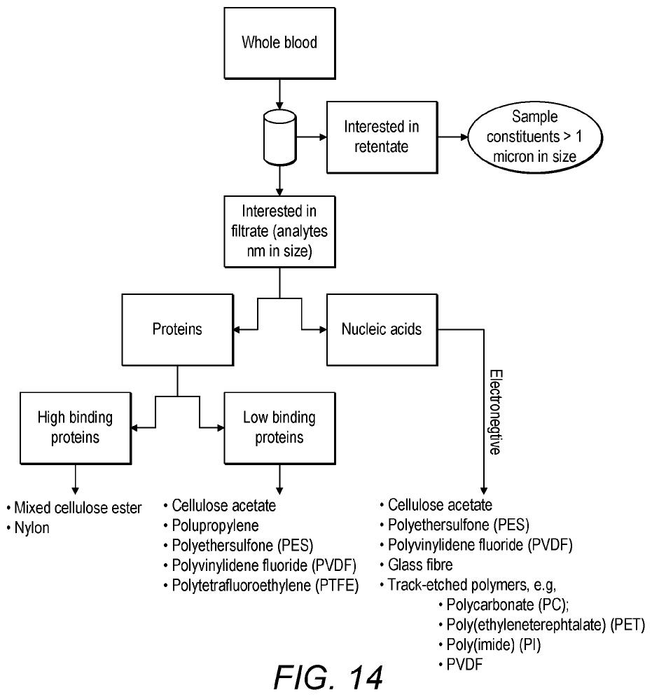

FIG. 14 is a schematic showing the rationale behind filter material selection;

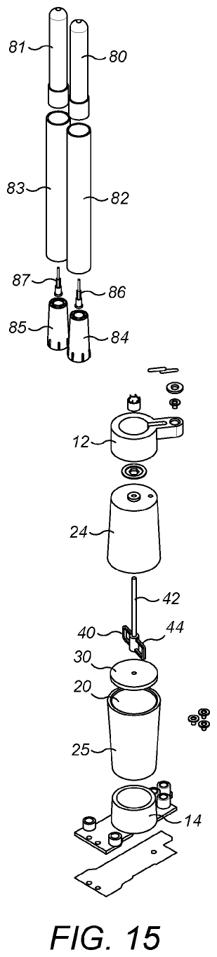

FIG. 15 shows an exploded view of the filtration unit in a cartridge format;

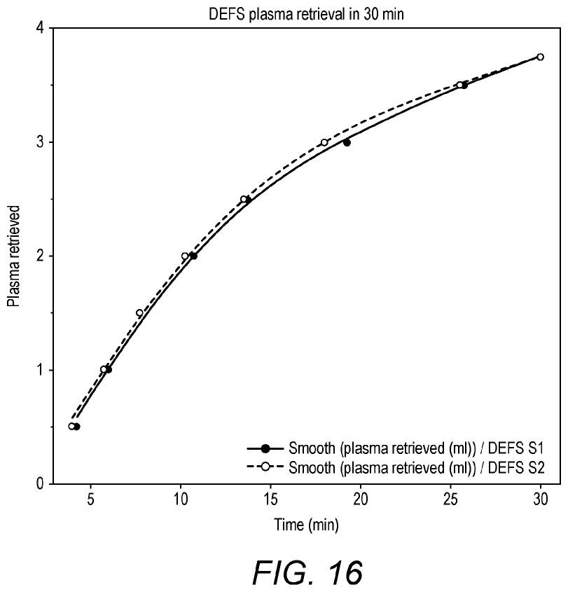

FIG. 16 is a graph showing the time taken to retrieve plasma in 0.5 ml fractions over a 30 minute period;

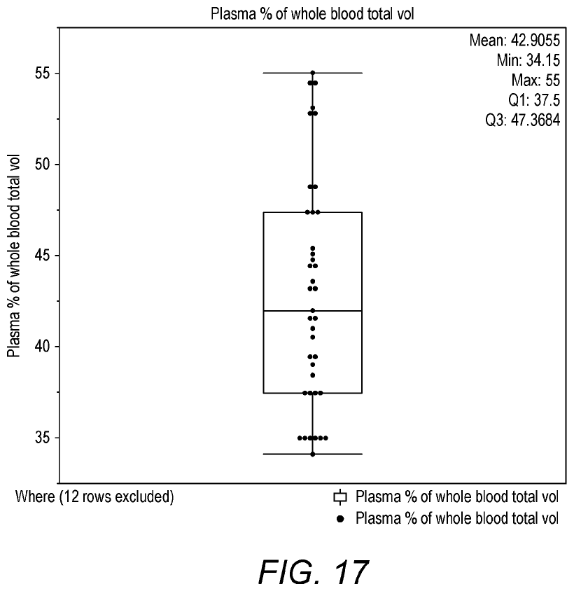

FIG. 17 shows the amount of plasma retrieved as a percentage of total whole blood;

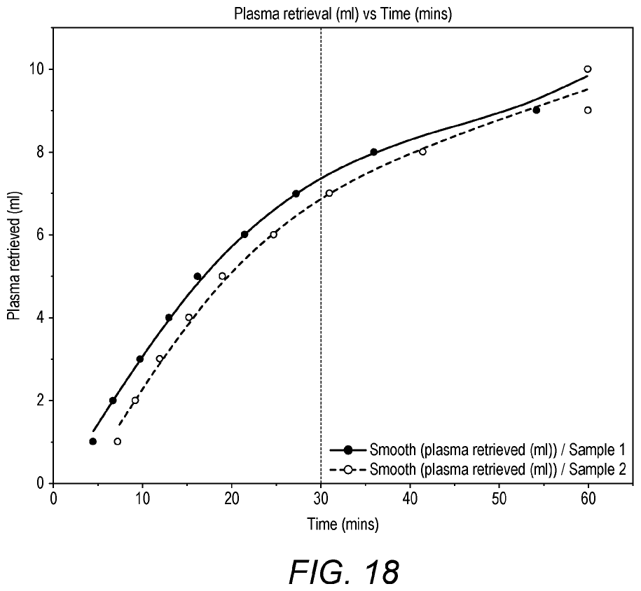

FIG. 18 is a graph showing the time taken to retrieve plasma in 1 ml fractions over a 60 minute period.

FIG. 1 shows an embodiment of the filtration unit 10 for separating at least one analyte from a fluid sample. The filtration unit 10 comprises a fluid pathway 20 providing fluid communication between an inlet 12 and an outlet 14. The fluid pathway 20 comprises a filter 30 located between the inlet 12 and the outlet 14. The fluid pathway 20 also comprises an impeller 40 adjacent to the filter 30. More specifically, the fluid pathway 20 comprises a first chamber 24, wherein the filter 30 and impeller 40 are located. The first chamber 24 has a greater cross-sectional area than the inlet 12 and/or outlet 14. However, in some embodiments, not shown, the cross-sectional area of the first chamber 24 is equal to the cross-sectional area of inlet 12 and/or outlet 14. Consequently, in some embodiments, the cross-section of the fluid pathway 20 is constant. The chamber 24 comprises a housing 25. In some embodiments, not shown, the chamber housing 25 may be the side wall 21 of the fluid pathway 20. In some embodiments, the inlet 12 is located in a top surface or lid 23 of the first chamber 25, as shown in FIG. 1.

The inlet 12 is configured to receive the fluid sample and the outlet 14 is configured to receive the at least one analyte. The fluid pathway 20 has a longitudinal axis 22 along which the fluid sample flows, in use. The cross-section of the fluid pathway may vary, as shown in FIG. 1. The fluid pathway adjacent to the filter comprises a first chamber 24. The chamber 24 has a larger cross-sectional area than the inlet and the out, thus enabling more efficient filtration of the sample. In some embodiments, as indicated in FIG. 5A and FIG. 5B, the orientation of the longitudinal axis 22 of the fluid pathway may vary. For example, the longitudinal axis 22 of the fluid pathway 20 between the inlet 12 and the filter 30 may be substantially vertical, whereas the longitudinal axis 22 of the fluid pathway 20 between the filter 30 and the outlet 14 may be substantially horizontal. Any orientation may be used. For example, the longitudinal axis 22 of the fluid pathway 20 may be curved or tortuous.

In some embodiments, the fluid pathway 20 is configured to receive a continuous supply of the fluid sample. Alternatively, in some embodiments, the fluid pathway 20 is sized to accommodate a fluid sample of up to 100 ml. Alternatively, the fluid pathway 20 may be sized to accommodate a fluid sample of up to 5 ml, 10 ml, 20 ml, 30 ml, 50 ml, 75 ml, 100 ml or more than 100 ml.

The filter 30 comprises at least one surface 32 configured to allow the passage of the at least one analyte. The at least one surface 32 of the filter 30 is substantially perpendicular to the longitudinal axis 22 of the fluid pathway 20 and comprises a plurality of pores sized between 100 nm and 10 μm. In some embodiments, not shown, the at least one surface of the filter may be at an angle β relative to the longitudinal axis of the fluid pathway. The angle β may be 90 degrees (i.e. perpendicular). Alternatives, the angle β may be up to 80, 70, 60, 50, 40 or 45 degrees relative to the longitudinal axis of the fluid pathway.

In some embodiments, not shown, at least one surface of the filter is convex. In some embodiments, not shown, at least one surface of the filter is concave or conical. Alternatively, or in addition, at least one surface of the filter comprises at least one portion that is parallel to the longitudinal axis 22 of the fluid channel 20. In some embodiments, the filter comprises at least two surfaces configured to allow the passage of at least one analyte. Each of the at least two surfaces may be at a different angle relative to the longitudinal axis of the fluid pathway. Non-flat filter surface profiles increase the surface area of the filter for a given fluid pathway cross-section, thus increasing the efficiency of the filtration unit.

The filter 30 is replaceable. The filter 30 may be replaced or swapped depending on the fluid sample and/or analyte for separation. The filter 30 may be a commercially available filter or a custom-designed filter. The filter 30 may be made from at least one of PVDF and PTFE. Other suitable material may also be used. Further details of the filter material selection are shown in FIG. 14. Taking the example of whole blood and the various analytes of interest that may be analysed with appropriate filter material selection, FIG. 14 shows the different filter materials that are appropriate for different analytes. Nucleic Acids (e.g., dsDNA, ssDNA, RNA) have a negatively charged phosphate backbone meaning to limit or eliminate non-specific adsorption on a filter membrane, a negative surface charge should facilitate passage, via plasma, through the hydrophilic porous (>70%) membrane. Depending on the sample to be filtered, the wettability of the filter material is an important consideration to achieve fluid flow through the pores. As the plasma is 92% water, a hydrophilic membrane is an optimal choice for unit operation.

Material compatibility is chosen to also ensure no adverse reactions occur to the particles flowing through the membrane or that is in contact on the retentate side of the filter. Inert polymers are especially suited for this, ensuring biocompatibility with cells that do not lead to cell lysis or necrosis. This applies not only to the filter 30, but all components in contact with the sample including the fluid pathway need to be bio-inert or at least biocompatible.

The filter may comprise pore sizes up to 5 μm. In some embodiments, the filter may comprise pore sizes up to 0.1 μm, 0.25 μm, 0.5 μm, 1 μm, 2 μm, 3 μm or 4 μm. The filter may comprise pore sizes larger than 5 μm.

Choice of filter pore size depends on constituent particulate size distribution which makes up the sample, and the fragment (cfDNA) size and/or molecular weight of the target analyte to be concentrated in the filtrate channels downstream of filter. Taking the example of whole blood, the constituent size distribution is as follows:

| Constituent | Size | |
|---|---|---|
| Diameter of red blood cells | 8 | μm |
| Thickness of red blood cells | 2 | μm |
| Radius of White blood cells | 3 to 15 | μm |
| Radius of Platelets | 1.0 to 1.5 | μm |
| Bacteria | 0.5 to 5.0 | μm |
| Viruses | Approximately | |
| | 100 to 800 nm | |
| Protein | 1.0 to 5.5 nm or | |
| | 5 to 500 kDa | |
| Cell free DNA | 1.0 to 10 | nm |

The pore size of the filter, stated in microns/μm is determined by the diameter of particles retained by the filter or by a bubble point test. The nominal ratings are the pore size at which a particle of defined size will be retained with efficiency in the region of 90-98%. For example, a filter size of 0.8 μm would be effective in removing red blood cells from plasma.

If much smaller particles are the analyte of interest, then the pore sizes may be compatible with what is typically defined to be microfiltration, wherein the analyte size is in the range of 0.1 to 5.0 μm or even ultrafiltration, wherein the analyte size is in the range of 0.01 to 0.1 μm. Under these conditions, the size is defined by the molecular weight cut off and the value selected should be 3 to 6 times smaller than that of the analyte to be retained for globular proteins. The molecule weight cut off for nucleic acids, both double stranded DNA and single stranded DNA to be retained within a filter are shown in the table below.

| | | |
|---|---|---|
| MWCO (Da) | dsDNA | ssDNA |

| | | | | |
|---|---|---|---|---|
| 1K | 5-6 | b.p | 9-32 | bases |
| 3K | 16-32 | b.p | 32-65 | bases |
| 5K | 25-50 | b.p | 50-95 | bases |
| 10K | 50-145 | b.p | 95-285 | bases |
| 30K | 145-285 | b.p | 285-570 | bases |
| 50K | 240-475 | b.p | 475-950 | bases |
| 100K | 475-1,450 | b.p | 950-2900 | bases |

FIG. 2A and FIG. 2B show an impeller 40 for use in some embodiments of the invention. The impeller 40 is located adjacent to the filter 30. The impeller comprises a rotatable shaft 42 coupled to at least one blade 44. The at least one blade 44 is coupled to the shaft 42 via a hub 49. However, any number of blades may be used. For example, in some embodiments, the rotatable shaft is coupled to 1, 2, 3, 4, 5, 6, 7, 8, 9, 10 or more than 10 blades.

FIGS. 3A to 3E each show an impeller suitable for use with the invention. Fluid agitation has a key role in processing operations, by maintaining a suspension of particles in the fluid, such that gravitational or sedimentation forces are minimized. This, in turn, reduces the rapid build-up of cake residue on top of the filter. The effectiveness of fluid agitation depends on the rheological properties (e.g., viscosity and density) of the fluid.

The effect of the rotating impeller, driven by the shaft 42, is to pump the liquid and create a regular flow pattern. Addition of baffles on the fluid pathway 20 adjacent the impeller 30 or the off-centre positioning of the impeller 30 reduced the creation of a central surface vortex which can lead to entrainment of air and reduction on radial or longitudinal flow. The baffles (not shown in the accompanying drawings) that have a thickness approximately 0.1×diameter of the fluid pathway 20, i.e. they occupy up to 10% of the diameter of the fluid pathway 20. It is the bulk direction of the velocity vectors or circulating currents created in the vessel and illustrated in FIG. 9 which distribute particles within the fluid and drive particle motion, reducing the rate of cake build up on top of the filter surface. The additional downward force of the fluid drives the flow of filtrate through the filter.

Focussing on the illustrated examples, FIG. 3A shows an impeller comprising one blade; FIG. 3B shows an impeller comprising two blades; FIG. 3C shows an impeller comprising three blades; FIG. 3D shows an impeller comprising four blades; and FIG. 3E shows an impeller comprising six blades. A variety of impeller designs may be used, wherein each differing design offers varying advantages dependent on the type of fluid sample and analyte of interest. At least one of a blade's geometry, size and angle relative to a longitudinal axis of the shaft 43 may be identical to at least one other blade. Alternatively, the impeller may comprise a plurality of blades each with different geometries, sizes and or angles relative to a longitudinal axis of the shaft 43.

In some embodiments, each of the blades comprises at least two opposing faces 47, 48 connected by an edge 45. The edge 45 is continuous and runs around the entire outer perimeter/boundary of the blade. Therefore, the edge 45 may define the boundary of each face 47, 48 of each blade 40. The edge 45 may be a rounded edge or a filleted edge. In some embodiments, the edge 45 is a rounded edge or a filleted edge and smoothly connects the opposing faces 47 and 48. A rounded or a filleted edge reduces the shear force applied to the fluid by the rotating impeller, in use.

As shown in FIG. 3C, at least a portion of the longitudinal profile of the edge is non-linear or curved 46. The non-linear or curved portion of the longitudinal profile of the edge 45 may be at an angle of approximately 20 degrees (i.e. ‘along the length’ of the edge) or approximately 90 degrees (i.e. at a ‘corner’). Alternatively, or in addition, the non-linear or curved portion of the longitudinal profile of the edge 45 may be at an angle of up to 10 degrees, 20 degrees, 30 degrees, 40 degrees, 50 degrees, degrees, 70 degrees, 80 degrees, 90 degrees or more than 90 degrees.

In some embodiments, at least a portion of the edge 45 is substantially parallel to at least one surface of the filter. In some embodiments, at least a portion of the edge 45 is substantially parallel to the longitudinal axis of the fluid pathway 22. The portion of the edge 45 that is substantially parallel to the longitudinal axis of the fluid pathway may be located up to 10 mm from a sidewall 21 of the fluid pathway 20. Alternatively, in some embodiments, the portion of the edge 45 that is substantially parallel to the longitudinal axis of the fluid pathway 22 is up to 1 mm, 2 mm, 3 mm, 4 mm, 5 mm, 6 mm, 7 mm, 8 mm, 9 mm, 10 mm or more than 10 mm from the sidewall 21. Consequently, the length of the blade (i.e. the distance between the hub 49 and the portion of the blade edge that is substantially parallel to the longitudinal axis of the fluid pathway) may be determined based on the required distance between the portion of the blade edge that is substantially parallel to the longitudinal axis of the fluid pathway and the sidewall 21 of the fluid pathway 20.

The at least one impeller blade 40 is configured such that it is always submerged by the fluid sample, in use. Consequently, the maximum distance of a blade 40 from the filter 30 is dictated by the sample size and the geometry of the fluid channel 20 or first chamber 24. In some embodiments, the maximum distance of the blade 40 from the filter 30 is up to 10 mm, 20 mm, 30 mm, 40 mm, 50 mm, 60 mm, 70 mm, 80 mm, 90 mm, 100 mm or more than 100 mm. However, the maximum distance of the blade 40 from the filter 30 is therefore dictated by geometry alone when a continuous supply of fluid sample is provided.

In some embodiments, the impeller comprises a plurality of identical blades. Each blade is coupled to a central hub 49 configured for attachment to the rotatable shaft 42. In some embodiments, as shown in FIG. 3C, each blade is positioned at an angle α relative to the longitudinal axis of the rotatable shaft 43. The angle α is approximately 45 degrees. However, in some embodiments, not shown, the blades are positioned at an angle α of up to 10 degrees, 20 degrees, 30 degrees, 40 degrees, 50 degrees, 60 degrees, 70 degrees, 80 degrees, or 90 degrees relative to the longitudinal axis of the rotatable shaft 43.

The minimum distance between the impeller 40 and the filter 30 is 1 mm. More specifically, the minimum distance between any portion of the blade 44 and the at least one surface of the filter 32 is 1 mm. However, in some embodiments, the minimum distance between the impeller 40 and the filter 30 is 0.1 mm, 0.3 mm, 0.5 mm, 0.8 mm, 1 mm, 2 mm, 3 mm, 4 mm, 5 mm, 6 mm, 7 mm, 8 mm, 9 mm, 10 mm, 20 mm, 30 mm, 40 mm, 50 mm or more than 50 mm.

The impeller 40 is configured to generate tangential fluid flow in the vicinity of the filter 30. Thus, in use, the fluid sample in the fluid pathway 20 located between the filter 30 and the impeller 40 flows substantially tangential relative to the filter 30, thus driving the flow of the analyte through the filter 30.

Selection of the optimum impeller design for a specific use case is dependent on the processing requirements of the sample input including shearing, flow regime, viscosity, reduction in particle damage. Illustrating this by extremes, two distinct approaches can be taken: provision of impellers with small blade area, rotating at high speed; and, conversely, impellers with large blade area, rotating at low speeds. The large blade area impeller is effective for high viscous liquids or non-Newtonian fluids such as whole blood. As they are low-shear impellers they are the best choice for agitating shear thickening fluids.

The filtration unit 10 further comprises a stepper motor 50. The stepper motor is operably connected to the impeller shaft 42 via a coupling 43. The stepper motor 50 is configured to rotate the impeller 40, in use. In some embodiments, the impeller 40 rotates at speeds of between 250-450 RPM. In some embodiments, the impeller 40 rotates at speeds of up to 25 RPM, 50 RPM, 100 RPM, 200 RPM, 250 RPM, 300 RPM, 350 RPM, 400 RPM or 450 RPM.

It is intended that the distribution process should remain in the laminar flow regime. General considerations depend on the impeller speed in RPM, as referenced above, impeller diameter and geometry and the properties of the fluid such as density and viscosity. For Newtonian fluids, this can be represented in terms of dimensionless numbers such as the impeller's Reynold's number (Reᵢ) and the power number (Nₚ). For non-Newtonian fluids, the power number is always dependent on the impeller's Reynold's number since reaching a turbulent flow regime for highly viscous or pseudo-plastic fluids including, for example, whole blood is difficult to achieve. Generally, non-Newtonian fluids consume less power than Newtonian (dilatant) fluids, though the size of the impeller should be large enough to sweep the bulk volume of the vessel with little clearance from the vessel walls.

In some embodiments, the impeller 40 is located between the inlet 12 and the filter 30, as shown in FIG. 1. In some embodiments, not shown, the impeller 40 is located between the filter 30 and the outlet 14. Alternatively, or in addition, in some embodiments, there is a plurality of impellers 40. For example at least one impeller 40 may be located between the filter 30 and the inlet 12 and/or at least on impeller 40 may be located between the filter 30 and the outlet 14.

In some embodiments, the fluid sample is biological matter, such as whole blood. However, any fluid sample may be used. In some embodiments, the analyte is plasma. However, any analyte may be separated from a fluid sample.

For example, in some embodiments, the fluid sample is 5-30 ml of whole blood and the analyte is plasma. The filter is made of PVDF or PTFE and comprises pore sizes of between 100 nm-5 μm. The impeller 40 rotates at speeds of between 250-450 RPM. Consequently, 2.5-15 ml of plasma is collected during a 10-30 minute period.

As shown in FIG. 2A and FIG. 2B, the impeller shaft 42 is tubular. However, any cross-sectional shape may be used for the shaft 42. For example, the cross-section of the shaft may be circular, triangular or rectangular. In some embodiment, the cross-section of the shaft is constant. In other embodiments, the cross-section of the shaft varies. A first end of the shaft is inserted into the central hub 49 and a second end of the shaft is coupled to the stepper motor 50. The shaft 42 may be coupled to the stepper motor 50 via a shaft coupling 43. The impeller shaft 42 may be flexible or rigid. The impeller shaft 42 may be formed of a material or coating that is tissue-compatible, serializable or auto-cleavable.

The length of the impeller shaft 42 is approximately 23 mm. Alternatively, or in addition, the length of the impeller shaft is up to 5 mm, 10 mm, 15 mm, 20 mm, 25 mm, 30 mm, 35 mm, 40 mm, 50 mm, 70 mm, 100 mm or more than 100 mm. The diameter of the shaft 42 is between 1 and 10 mm. In some embodiments, not shown, the diameter of the shaft may be up to 1 mm, 2 mm, 3 mm, 4 mm, 5 mm, 6 mm, 7 mm, 8 mm, 9 mm, 10 mm, 15 mm, 20 mm, 30 mm or more than 30 mm. In some embodiments, the diameter of a first end of the shaft is substantially equal to the diameter of a central portion of the hub 49.

FIG. 4 shows a portion of the fluid pathway 20. The fluid pathway 20 is circular in cross-section and is hollow. Consequently, the fluid pathway is a conduit configured to enable the flow of fluid along its longitudinal axis 22. However, any suitable cross-section may be used, such as rectangular, square, triangular or any other polygonal shape. The impeller 40 and the filter 30 are positioned inside the fluid pathway 20. The inlet 12 is located at a first end of the fluid pathway 20 and the outlet 14 is located at a second end of the fluid pathway. The length of the fluid pathway is up to 5 mm, up to 100 mm or even up to 500 mm, wherein the length of the fluid pathway is the distance between the inlet and the outlet when measured along the longitudinal axis of the fluid conduit. More specifically, FIG. 4 shows the first chamber 24 located within the fluid pathway 20. The impeller 40 and the filter 30 are positioned inside the first chamber 24 of the fluid pathway 20.

FIG. 5A and FIG. 5B show a portion of the fluid pathway 20 located between the filter 30 and the outlet 14. In some embodiments, as shown in FIG. 5A and FIG. 5B, the direction of fluid flow in fluid pathway 20 located between the filter 30 and the outlet 14 is substantially perpendicular to the direction of flow the fluid pathway located between the inlet 12 and the filter 30. Alternatively, in some embodiments, as shown in FIG. 1, the direction of fluid flow in fluid pathway 20 located between the filter 30 and the outlet 14 is substantially parallel to the direction of flow the fluid pathway located between the inlet 12 and the filter 30. In some embodiments, not shown, the direction of fluid flow in fluid pathway 20 located between the filter 30 and the outlet 14 transverse to the direction of flow the fluid pathway located between the inlet 12 and the filter 30. The transverse angle may be up to 10 degrees, 20 degrees, 30 degrees, 40 degrees, 50 degrees, 60 degrees, 70 degrees, 80 degrees or 90 degrees relative to the direction of fluid flow in fluid pathway 20 located between the filter 30 and the inlet 12. A substantially perpendicular or transverse portion of the fluid pathway located between the filter 30 and the outlet 30 decreases the overall size of the filtration unit 10. Furthermore, a substantially perpendicular or transverse portion of the fluid pathway located between the filter 30 and the outlet 30 improves the manufacturability of the filtration unit.

The fluid channel 20 adjacent to the filter 30 and located between the filter 30 and the outlet 14 comprises at least one substantially flat surface 26. The at least one substantially flat surface 26 comprises an opening configured to receive the analyte that passes through the filter 30. In some embodiments, the fluid channel 20 may be ‘U-shaped’ in cross-section, wherein the filter 30 is positioned along the substantially flat top of the fluid pathway. However, the fluid pathway may comprise any cross-sectional shape.

FIG. 6 shows a stand 60 configured to receive the filtration unit 10. The filtration unit 10 can be placed on the stand, which includes a filtration unit holder 62, stand top 64, and four spacers 65 connected to a bottom plate 66.

FIG. 7 shows an instrument 70 configured to receive the filtration unit 10 and the stand 60. The instrument 70 is configured to support the stepper motor 50. The stepper motor 50 is connected to the impeller 40 via the rotatable shaft coupling 43. The stepper motor 50 provides the impeller 40 with the rotational motion required to obtain the tangential flow within the fluid pathway, thus generating the transmembrane pressure across the filter in the filtration unit. The motor 50 is mounted on a 90-degree bracket 72, which is attached to a linear rail 74. The rail height can be automatically or manually controlled.

Computational fluid dynamic (CFD) modeling was used to study the mechanistic principle of the filtration unit and to evaluate flow velocities and pressures with the dead end filtration unit with stiring (DEFs) system. The filter and the impeller design were replicated in the CFD software, and to optimize computational cost, the symmetry across the filtration unit features was used.

In the simulation, the filtration unit is modelled with 10 ml of blood at hematocrit levels of 40 or 80%, where the first one is the representative levels of hematocrit when no plasma has been filtered out whereas the second one represents increased cell concentrations as the plasma is filtered. The impeller speed was set to 450 or 250 revolutions per minute (RPM). The blood was simulated as a non-Newtonian fluid following Carreau's model of a shear-thinning fluid, while due to Reynolds numbers greater than 10, the physics was solved using a k-e turbulent model. Flow velocity analysis at the bottom of the filtration unit (e.g. where the filter is placed) of blood stirred at 450 RPM showed that velocities ranged between 72-520 mm/s, as shown in FIG. 8A.

Areas of high velocity were located towards the outer edges of the filtration unit, whereas areas of lower velocity were observed towards the center of the DEFS. At the start of the filtration process, blood was assumed to have 40% hematocrit. As the plasma passed through the filter the hematocrit levels increased reaching levels of 80%. No change in flow velocity as a function of hematocrit was observed, as shown in FIG. 8B.

Blood velocity analysis showed that as the impeller rotates as illustrated schematically in FIG. 9A. Vortexes are created upstream of the blade, as shown in FIG. 9B. These vortexes impose a recirculation effect on cells, stirring them up from their undisturbed state. Downstream of the blade a wiping mechanism is created, as shown in FIG. 9C.

The combination of the stirring up and wiping of cells is likely to reduce filter fouling while promoting continuous aqueous plasma filtration. The fluid motion imposed by the rotating blade resulted in increased pressure at the bottom of the filter unit, as shown in FIG. 10.

At 450 RPM and hematocrit levels of 40%, the pressure reached 4 kPa, as shown in FIG. 11. The pressure almost doubled at the end of the filtration process when the hematocrit approached 80%. This was linked to increased viscosity as a result of high blood cells' concentrations.

The mechanistic principle extrapolated via CFD was tested experimentally. Whole human blood (10 ml) was introduced into the DEFS, where the filtration unit contained either a filter with 0.65 μm pore size made of PVDF or 1 μm pore size made of PTFE. The impeller speed was set at 450 RPM and the volumes of plasma filtered were measured over time, as shown in FIG. 12.

After 30 minutes 90% and 75% of the plasma was retrieved using the 1 or 0.65 μm filter placed in the DEFS, respectively. To show that the DEFS can be used to isolate plasma and retrieve cfDNA, 9 ml of human whole blood was spiked with 50 ng/ml 5% mutant allele fraction (MAF) cfDNA and loaded in the filtration unit containing the 0.65 μm pore PVDF membrane filter while the impeller speed was set at 450 RPM, as shown in FIG. 13. The filtrated plasma was collected in 1 ml fractions and cfDNA extraction was performed using a commercially available kit. Allele-specific probe-based qPCR was used to determine cfDNA extraction efficiency. cfDNA recovery from human whole blood was demonstrated on the DEFS system proving that in principle, the filtration unit can be used for plasma separation and potential downstream extraction of analytes from high-quality plasma.

Consequently, the filtration unit has potentially broader applications, comprising: various sample types/liquid biopsies; several diseases and biomarkers (cfDNA—tested, RNA, exosomes, proteins); batch (tested) and continuous process; high yield with compact size; standalone lab use or integration into diagnostic device; and possible integration into consumable format.

The filtration unit relies on a novel mechanism of plasma filtration. Exploitation of the radial motion transmitted by the impeller results in the continuous recirculation of cells and perpendicular fluid forces that drive the plasma through the filter without the need for external pressure. The additional novelty of this invention is the modular concept for which requires minimum personnel handling, thus it is adaptable to a downstream automation process as well as integration within a compact diagnostic device upon further miniaturization. The process allows immediate separation of plasma and blood cells for further analysis. A standardized device ensures uniformity of the results and thus strongly advantageous over the current manual processing methods.

FIG. 15 shows an exploded view of the filtration unit in a cartridge format. As previously described, with reference to FIGS. 1 to 5B, the filtration unit comprises a fluid pathway 20 providing fluid communication between an inlet 12 and an outlet 14. The fluid pathway 20 comprises a filter 30 located between the inlet 12 and the outlet 14. The fluid pathway 20 also comprises an impeller 40, having a rotatable shaft 42 and at least one blade 44, adjacent to the filter 30.

However, in some embodiments, as shown in FIG. 15, the filtration unit is further configured to receive at least one vacutainer 80, 81 comprising the sample to be filtered. More specifically, the filtration unit comprises two vacutainer guide sleeves 82, 83 each located within a support 84, 85. Moreover, each vacutainer guide sleeves 82, 83 comprises a luer needle 86, 87 configured to penetrate the vacutainer 80, 81 and cause the sample to enter the fluid pathway 20 via the inlet 12.

The following example details one possible setup of the filtration unit and the resulting performance in terms of plasma recovery, haemolysis, gDNA contamination from WBC lysis, and cfDNA recovery. For example, a filtration unit having a chamber housing, first chamber, acrylic lid, filter membrane and impeller, in accordance with the present invention, was position within a stand and coupled to a stepper motor. A trinamic stepper motor driver and software was used. The impeller was 3D printed and was formed as shown in FIG. 3A. The filtration unit was assembled with a 0.65 um membrane filter in place. The filter was 47 mm in diameter and fabricated from hydrophilic polyvinylidene fluoride (PVDF) having 0.65 μm track-etched pores. The distance between the impeller and the filter was 0.37 mm.

The stepper motor and impeller was then removed from the setup and put aside. A 50 ml conical tube lid was placed adjacent to the outlet and configured to capture the plasma, in use, and 1500 μl STEMCELL EasySep Buffer was the pipetted onto the internal surface of the chamber housing (the dead-volume part of the unit). All surfaces that would come into contact with plasma were completely coated. A white diffuser disc was then inserted over the coated chamber housing.

All interior surfaces of the filtration unit, including the membrane filter, were then pre-wet with 500 μl STEMCELL EasySep™ Buffer (Dulbecco's PBS, 2% FBS, 1 mM EDTA). Bubble generation of pre-wetting buffer was limited to prevent the membrane from clogging.

The filtration unit was then re-positioned in the stand. Without letting the filtration unit dry out, the full blood volume from the vacutainer was poured into the filtration unit less than 10 s after pre-wetting. The stepper motor/impeller was placed back onto the stand, ensuring there was free movement of the impeller above the membrane filter. The impeller was then rotated with velocity of 400,000 ppt (^{˜}450 rpm) and acceleration at 200 ppt using the Trinamic Stepper motor driver and software.

The flow of plasma through the filter was collected in the 50 ml conical tube lid in 1 ml fractions using a pipette to confirm volume. The time to collect each 1 ml fraction was recording for the entire 30 minute run time. A picture was taken of the fractions for a qualitative check on plasma quality (haemolysis).

The filtration unit was operated for 30 minutes and a single 10 ml vacutainer was used to deliver the sample. Atmospheric pressure was used throughout, unless specifically stated otherwise.

FIG. 16 is a graph showing the time taken to retrieve plasma in 0.5 ml fractions. A near linear trend is observed for the first 2 ml of plasma retrieved (^{˜}0.3 ml/min) with a gradually decreasing slope for the remaining collection. Plasma recovered was recorded as a percentage of plasma retrieved out of the total whole blood volume. FIG. 17 shows the amount of plasma retrieved as a percentage of total whole blood. On average, the filtration unit retrieves 43% of plasma of the whole blood volume (34.15-55%). However, it has been observed that approximately 0.75 ml of plasma is consistently retained within chamber housing in the dead volume space underneath the filter membrane. This plasma cannot be retrieved without disassembling the filtration unit.

The filtration unit has a diameter of 47 mm, a depth of 30 mm, a total volume of 50 ml and receives a 47 mm diameter hydrophilic PVDF membrane filter. The filter membrane comprises 0.65 μm track etched pores, which filters the plasma from the whole blood. When 10 ml of whole blood is added to the DEFS, it takes approximately 30 minutes to retrieve the total plasma volume, with no clogging of the filter observed.

Moreover, total whole blood volume was increased to 20 ml and the filtration unit was run for 60 minutes with the time to achieve each 1 ml plasma fraction recorded and shown in FIG. 18. A similar asymptotic trend and similar initial max flow rate (^{˜}0.3 ml/min) was observed, with no clogging seen.

As previously mentioned, it is also important to determine and reduce the amount of cell lysis that occurs within the filtration unit. Red blood cell (RBC) lysis in the whole blood sample from dead end filtration with stirring (DEFS) will result in the release of intracellular haeme, which is a well-known polymerase chain reaction (PCR) inhibitor. Some techniques, such as dilution and/or use of haeme-resistant enzymes, can help reduce the effects of inhibition, but other assay sensitivity requirements and sample volume limitations prevent these as total solutions. Thus, all attempts to limit RBC lysis in DEFS should be made. When there is a high level of visible lysis in the DEFS isolated plasma, PCR inhibition can be tested by testing a sample both neat and 50% diluted. If haeme is present at a level significant enough to inhibit PCR, then the 50% diluted sample will amplify before the neat sample. Typically, DEFS isolated plasma has no or minimal haemolysis and is “straw-like” in colour. However, no PCR inhibition was detected in the most visibly haemolysed DEFS isolated plasma samples when using the filtration unit of the present invention as outlined above.

Furthermore, white blood cell (WBC) lysis in the whole blood sample from DEFS will result in an overabundance of non-target hgDNA and, when sequenced, a loss of signal in target cfDNA. The level of both hgDNA contamination and total DNA in DEFS isolated plasma can be determined using two PCR assays, namely:
1. An hgDNA assay targeting 815 bp of a single-copy gene, which excludes any of the target cfDNA fragments.
2. A total DNA assay targeting 165 bp of a single-copy gene with a common oncologic hotspot mutation. This assay can also be used with allele specific probes to detect mutant allele frequency (MAF) of recovered cfDNA.

Subtracting the amount of gene copies detected in the first assay from the second gives the total number of copies of target cfDNA. The DEFS plasma isolation performance of the aforementioned method using the filtration unit of the present invention shows <50 copies hgDNA present in 1 ml plasma compared to the target cfDNA concentration LoD of 290 copies in 1 ml plasma.

Additionally, an orthologous assay targeting a synthetic (non-human) 165 bp gBlock fragment may be used, which, when spiked, allows its recovery to be assessed independent from background DNA present in the sample.

Five different types of blood collection tubes were tested for compatibility with DEFS plasma retrieval—K2EDTA, ACD-A, Roche cfDNA, Streck BCT, and Streck Cyto-chex. All collection tube types allowed for plasma retrieval (>70%), however with differing yields, cfDNA recoveries, and cell lysis. K2-EDTA and ACD-A performed the best with reproducible plasma recovery (>90%) and cfDNA recovery (>60%) with minimal cell lysis.

Moreover, in some embodiments, a contrived whole blood sample, that is DNA-free, can be used to spike a known amount of cfDNA reference material (or any other reference material of interest). The recovery of said material can be determined using DEFS plasma isolation. The method of preparation comprises the following steps: Obtain a single 10 ml vacutainer of fresh human whole blood; Centrifuge for 10 min @ 1000 g @ 4° C.; Manually pipet off the plasma supernatant, leaving behind 0.5 ml of plasma to preserve the buffy coat (Note the volume of plasma removed); Add 1 ml of SensID human-tech plasma (synthetic plasma containing all major constituents of normal healthy collected plasma—proteins, EDTA, etc.) and mix; Centrifuge for 10 min @ 1000 g @ 4° C.; Manually pipet off the plasma supernatant, leaving behind 0.5 ml of plasma to preserve the buffy coat; Add the same volume of SensID human-tech plasma as the volume of plasma supernatant that was removed in the previous step and mix.

Thus, in summary, the present invention aims to develop an automatable centrifugation-free plasma isolation method with critical requirements of 10-20 ml human whole blood sample input volume with a 30-minute process time. Additionally, the device must have minimal white and red blood lysis and be compatible with downstream qPCR and sequencing.

One key requirement for the DEFS device is to retrieve a 3.5-5.0 ml plasma volume. On average, DEFS retrieves 43% of plasma of the whole blood volume and therefore meets this requirement. The main variables of plasma retrieval volume are the volume of blood drawn through phlebotomy and haematocrit levels. Up to 20 ml of whole blood can be added to the filtration device without any membrane filter clogging or caking.

Most of the plasma recovered from DEFS is the desired “straw-like” colour with no haemolysis observed by qualitative assessment. Occasionally a haemolysis gradient is seen across the plasma fractions, with plasma appearing redder in colour. This gradient may be attributed to blood draw, patient to patient variability or the blood collection tubes. Additionally, haemolysis may be occurring due to issues when pre-wetting the DEFS unit. EasySep buffer is currently being used to pre-wet/block the DEFS surface, however it has been observed that any drying of the filter or the presence of bubbles results in a reduced amount of plasma retrieved or clogging. Siloxane coating of the under cup of the DEFS unit has also been shown to be equivalent, but not better, to pre-wetting with EasySep buffer in reducing the plasma lost in the dead-volume. Despite the presence of haemolysis, any haeme carryover is not causing any downstream qPCR issues, which indicates that the present filtration unit and cfDNA isolation procedures will be compatible with next generation sequencing (NGS). While some samples showing red blood cell lysis and haeme carryover, hgDNA contamination from white blood cell lysis remains consistently at or below the limit of detection of the hgDNA-specific qPCR assay.

Various further aspects and embodiments of the present invention will be apparent to those skilled in the art in view of the present disclosure. “and/or” where used herein is to be taken as specific disclosure of each of the two specified features or components with or without the other. For example, “A and/or B” is to be taken as specific disclosure of each of (i) A, (ii) B and (iii) A and B, just as if each is set out individually herein.

Unless context dictates otherwise, the descriptions and definitions of the features set out above are not limited to any particular aspect or embodiment of the invention and apply equally to all aspects and embodiments that are described. It will further be appreciated by those skilled in the art that although the invention has been described by way of example with reference to several embodiments, it is not limited to the disclosed embodiments and that alternative embodiments could be constructed without departing from the scope of the invention as defined in the appended claims.

1-19. (canceled)

20. A filtration unit for separating at least one analyte from a fluid sample, the filtration unit comprising:
an inlet configured to receive the fluid sample and an outlet configured to receive the at least one analyte;
a fluid pathway providing fluid communication between the inlet and the outlet, wherein the fluid pathway has a longitudinal axis along which the fluid sample flows, in use;
a filter located in the fluid pathway, wherein the filter comprises at least one surface configured to allow the passage of the at least one analyte and wherein the at least one surface is substantially transverse to the longitudinal axis of the fluid pathway; and
an impeller located adjacent to the filter, wherein the impeller is configured to generate tangential fluid flow in the vicinity of the filter and wherein the impeller comprises a rotatable shaft coupled to at least one blade having a rounded leading edge.

21. The filtration unit according to claim 20, wherein the impeller comprises a plurality of blades each having a rounded leading edge.

22. The filtration unit according to claim 20, wherein the rotatable shaft is circular in cross section.

23. The filtration unit according to claim 20, wherein the impeller is located between the inlet and the filter.

24. The filtration unit according to claim 20, wherein the impeller is spaced apart from the filter.

25. The filtration unit according to claim 20, wherein the filter is replaceable.

26. The filtration unit according to claim 20, wherein the at least one surface of the filter is substantially perpendicular to the longitudinal axis of the fluid pathway.

27. The filtration unit according to claim 20, wherein the at least one surface of the filter comprises a plurality of pores sized between 1 nm and 10 μm.

28. The filtration unit according to claim 20, wherein the filtration unit comprises a plurality of filters.

29. The filtration unit according to claim 20, wherein the fluid pathway is a conduit.

30. The filtration unit according to claim 20, wherein the filtration unit is configured to maintain a fluid flow rate through the filter of 20-30 ml per hour.

31. The filtration unit according to claim 20, further comprising a pump configured to increase the pressure difference across the filter.

32. The filtration unit according to claim 23, wherein the pump is configured to generate a negative pressure between the filter and the outlet.

33. The filtration unit according to claim 20, wherein the impeller is replaceable.

34. The filtration unit according to claim 20, wherein the filtration unit further comprises a stepper motor operably connected to the impeller shaft and wherein the stepper motor is configured to rotate the impeller shaft at 250-450 RPM, in use.

35. The filtration unit according to claim 20, wherein the fluid sample comprises between 10⁰-10⁸ particles/ml of the analyte.

36. The filtration unit according to claim 20, wherein the analyte is a protein.

37. The filtration unit according to claim 20, wherein the fluid sample is biological matter.

38. The filtration unit according to claim 20, wherein the fluid pathway is sized to accommodate up to 30 ml of the fluid sample.
